(19) United States
(12) Patent Application Publication
(10) Pub. No.: US 2009/0295600 A1
(43) Pub. Date: Dec. 3, 2009

(54) Eletronic Flight Instrument

(76) Inventors: David Robert Stubben, Cameron Park, CA (US); Todd Keller Sprague, Placerville, CA (US)

Correspondence Address: David Stubben, 3242 Western Dr., Cameron Park, CA, 95682, US

(21) Appl. No.: 12/131,817

(22) Filed: Jun. 2, 2008

(51) Int. Cl. G07C 5/00; G01P 15/00; G01P 5/14

(52) U.S. Cl. 340/945; 340/974; 340/977; 340/978; 340/979; 73/488

(57) ABSTRACT

A flight instrument, having an electronic display, is configured to fit within a standard instrument mount and within an array of standard instrument mounts. The instrument has the ability to emulate any standard or other instrument. This instrument can share its installed optional sensors with other instances of itself that do not include the optional sensors by way of network interfaces. The instrument can contain emulation for all standard instruments and have a menu to select which to display.

### BACKGROUND OF THE INVENTION

1. Field of the Invention

The present invention relates to a system and method for electronic flight instrumentation including sensing and display of information to enable control and management of aircraft.

2. Description of Related Art

Historically, flight instruments have been mechanical and electromechanical in nature. Conventional instruments fit their display into either a 2.25 inch or 3.125 inch round hole in aircraft instrument panels as a standard. The instrument was mounted to the panel from the rear and the display area was restricted to the round hole. The “Basic Six” instruments used for flight control are Altimeter, Airspeed, Attitude Indicator, Turn Coordinator, Vertical Speed Indicator and Heading Indicator. The instrument panel is normally configured to mount an array of standard instruments in close proximity, with only 0.25″ to 0.5″ spacing between the instruments. More recently, larger electronic displays have become available, using, for example, Liquid Crystal Display (LCD) technology. Other recent technologies are Plasma Displays, Electroluminescent Displays, Organic Light Emitting Diode (OLED) Displays and others. These displays do not fit the standard round holes in the instrument panel—they are typically rectangular in shape and are available in a range of sizes from 1″ diagonal to several feet in diagonal. Due to cost considerations and their flexible functionality, the more modern flight instruments employ electronic displays that are larger than the standard hole patterns and have multiple simulated standard instruments displayed simultaneously on a single large display (larger than the panel space area occupied by or allocated to single 2.25 inch or 3.125 inch instruments.) Electronic displays require a controller to present and manipulate the display. A sensor system may be connected to the controller, usually a microprocessor, to provide the information that is presented on the display. The sensor system can include a magnetometer (electronic compass), a rate gyro for pitch, a rate gyro for yaw, a rate gyro for roll, an accelerometer, an absolute pressure sensor for altitude and a differential pressure sensor for airspeed.

### SUMMARY OF THE INVENTION

The present invention uses an LCD display (other electronic display technology may be used) and is configured to mount in existing 2.25 inch standard panel holes or 3.125 inch standard panel holes. The present invention includes a part that mounts behind the instrument panel—the instrument housing—and a part that mounts in front of the instrument panel—the bezel housing. The instrument housing contains the controller, network interfaces and an optional sensor system. The bezel housing contains the LCD display and a display interface printed circuit board (PCB). The size of the instrument housing behind the instrument panel allows placement in the standard array of standard holes. The size of the bezel housing in front of the instrument panel also allows placement in the standard array of standard holes. One objective of the present invention is to maximize the size of the display within the above described limitations. The instrument housing is secured to the instrument panel and is electrically connected to the display interface PCB through the standard hole. The bezel housing is secured to the instrument panel and the instrument housing.

As mentioned above, the instrument housing contains the controller, the network interfaces and the optional sensor system. The controller controls the display and instrument operation. It includes a microprocessor with Random Access Memory (RAM), program memory, optional database memory and support circuitry. The optional database memory may be a Universal Serial Bus (USB) memory stick, SD memory card or equivalent. The network interfaces include two RS-232 interfaces, one RS-422 interface and one RS-485 interface. One RS-232 interface may be connected to a Global Positioning System (GPS) that is external or installed internal to the instrument. One RS-232 or RS-422 interface may be connected to a remote Magnetometer (to minimize magnetic distortion from nearby ferrous metals, if necessary). One RS-232 or RS-422 interface may be connected to an input/output module to sense flight control positions, gear positions or radio navigation CDI signals. One RS-232 or RS-422 interface may be connected to a radio data module to obtain traffic and or weather information (for example, an ADS-B Universal Access Transceiver.) One RS-485 interface may be connected to other instances of the present invention. (For example, only one instance of the present invention may contain the optional sensor system, information from which is communicated to other instances of the present invention that do not contain the optional sensor system via the RS-485 network, in order to minimize cost while sharing sensor system information.) The optional sensor system includes a magnetometer (electronic compass), a rate gyro on each axis, a three axis linear accelerometer, an absolute pressure sensor, a differential pressure sensor and a sensor system controller. Additional network interfaces may include Ethernet, USB and ARINC429. RS-232, RS-422, RS-485, USB and ARINC429 are serial network interfaces.

As mentioned above, the bezel housing contains the LCD display and the LCD interface PCB. Additionally, a user accessible USB port is placed on the LCD interface board next to the LCD in order to facilitate instrument software updates and database uploads (for example, terrain information) and downloads (for example, recorded flight parameters). User accessible switches are placed next to the LCD as well to allow instrument control by the user.

An array of electronic flight instruments may be used to replace the “Basic Six” instruments. Only one of the instruments may contain a sensor system to minimize cost. More than one of the instruments may contain a sensor system for redundancy and enhanced reliability.

A single electronic flight instrument may be added to a standard instrument panel to act as a backup instrument to standard instruments in case of a failure of one of the standard instruments. In this case the user may select the functionality of the single electronic flight instrument from a menu of the “Basic Six” instruments and other instruments.

Other applications of the electronic flight instrument include terrain mapping, ground proximity warning information, weather display, traffic display, flight data recording, navigational display, G-meter, flight timer/clock and airman information display. The function of the instrument may be determined by menu selection, software importation via the front panel USB connection or fixed by factory configuration.

As may be appreciated after reviewing the present specification, the present invention overcomes many problems associated with replacing traditional instruments within a standard hole and hole array in an instrument panel and facilitates the in flight replacement of a failed instrument.

### BRIEF DESCRIPTION OF THE DRAWINGS

The present invention may be better understood, and its many features and advantages made apparent to those skilled in the art by referencing the attached drawings.

FIG. 1 shows the geometry of the 2.25 inch instrument.

FIG. 2 shows the geometry of the 3.125 inch instrument.

FIG. 3 is a block diagram of an electronic flight instrument in accordance with the preferred embodiment of the present invention.

FIG. 4 is a block diagram of a specific implementation of a networked array of the present invention in a typical installation.

FIG. 5 is a menu display of the present invention in a replacement application.

### DESCRIPTION OF PREFERRED EMBODIMENT

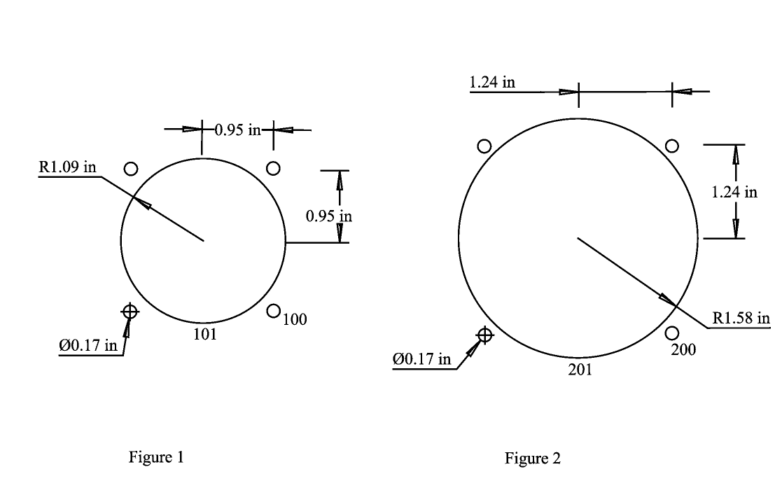

FIG. 1 shows the geometry of the 2.25 inch standard instrument mount. Four holes 100 are used to secure the instrument to the panel. Hole 101 is used to view the instrument face of a standard instrument. Hole 101 is used as a window for electrical connections between the LCD interface contained in the bezel housing and the processor board contained in the instrument housing in the present invention.

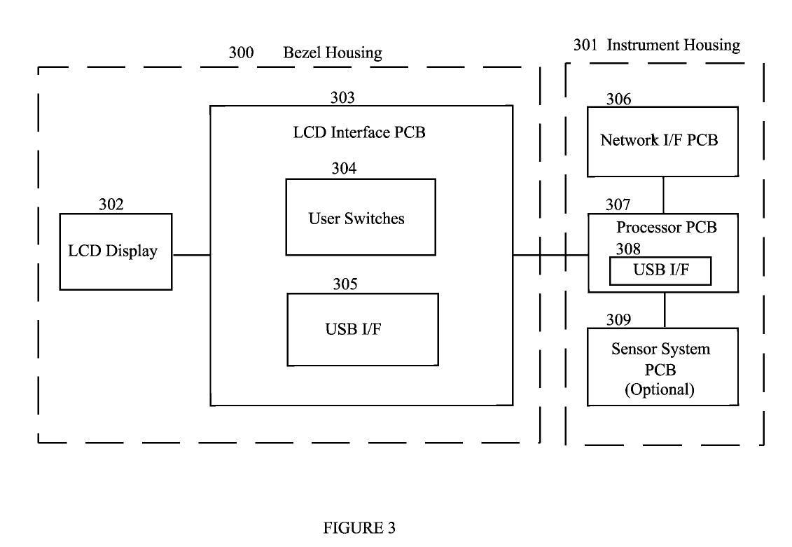

FIG. 2 shows the geometry of the 3.125 inch standard instrument mount. Four holes 200 are used to secure the instrument to the panel. Hole 201 is used to view the instrument face of a standard instrument. Hole 201 is used as a window for electrical connections between the LCD interface contained in the bezel housing and the processor board contained in the instrument housing in the present invention.

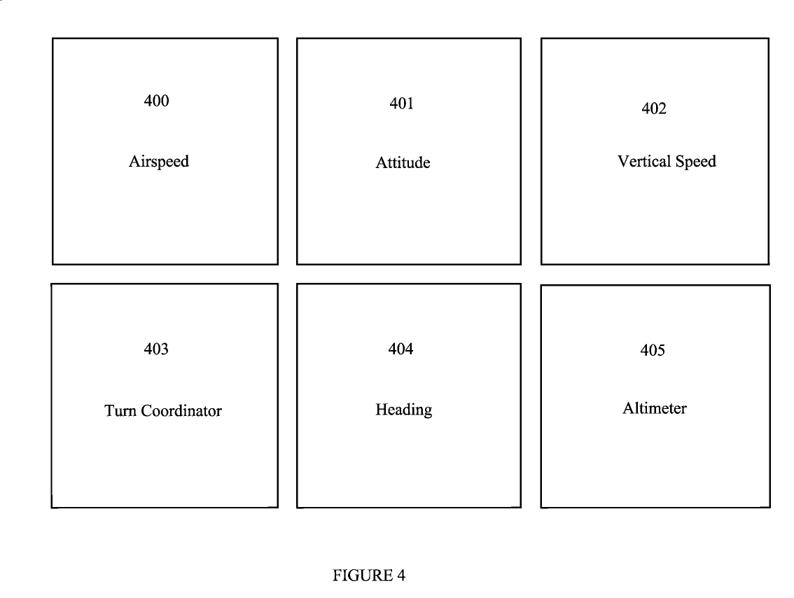

FIG. 3 is a block diagram of an electronic flight instrument in accordance with the preferred embodiment of the present invention. The Bezel housing 300 contains the LCD interface printed circuit board (PCB) 303. Mounted on and connected with the LCD interface PCB 303 is the LCD display 302. An example of the LCD display for the 3.125″ instrument is the Optrex T-51963GD035J. Also mounted on the LCD interface PCB 303 are user switches 304 and user accessible USB interface 305. The Bezel housing 300 is mounted to the front of the instrument panel. The instrument housing 301 is mounted behind the instrument panel. It contains the Processor PCB 307, Network Interface PCB 306 and optional Sensor System PCB 309. Included on Processor PCB 307 is a non user accessible USB interface 308. The Processor PCB 307 contains the microprocessor (a Cirrus Logic EP9307 is used), RAM memory (two Micron MT48LC 16M 16A2 parts are used), Flash program memory (a Spansion S29GL512N is used), an expansion memory card connector (a USB memory stick is used) and connectors to the other PCBs. The Network Interface PCB 306 contains an RS-485 network interface (Maxim MAX3491E), RS-422 network interface (Maxim MAX3491E), duel RS-232 network interfaces (Maxim MAX3232Es) as well as audio, power regulation and connector circuitry. The System Sensor PCB 309 contains a control microprocessor (NXP LPC2138), magnetometer magnetoresistive sensors (Honneywell HMC1051Z and HMC1052), a three axis accelerometer (Freescale MMA7260Q), three rate gyros (Analog Devices ADIS16255s), an absolute pressure sensor (Freescale MPXAZ6115AP), a differential pressure sensor (Freescale MPXV5010DP) as well as support circuitry and connectors.

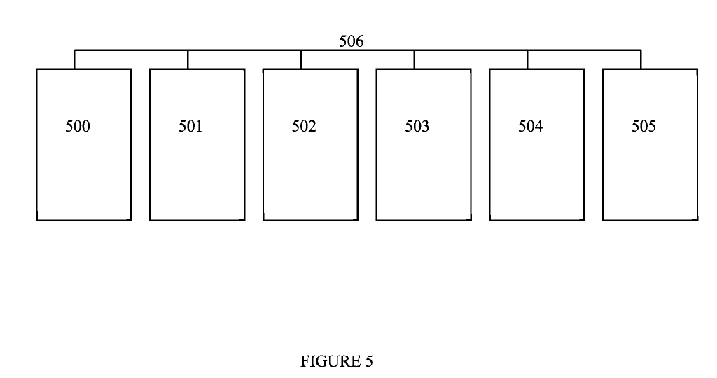

FIG. 4 is a block diagram of a specific implementation of an array of instruments of the present invention in a typical installation. Altimeter 405, Airspeed 400, Attitude Indicator 401, Turn Coordinator 403, Vertical Speed Indicator 402 and Heading Indicator 404 are configured in an arrangement known as the “Basic Six”. Additional types of instruments as noted above may be added.

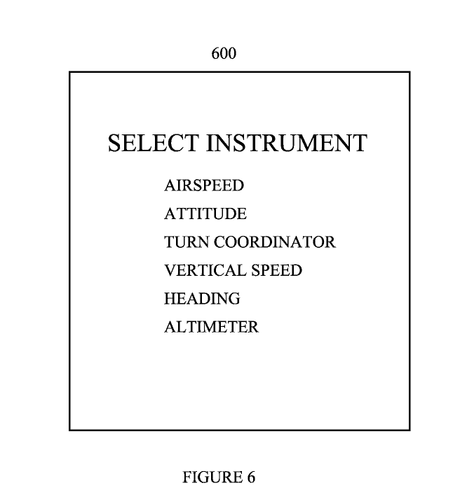

FIG. 5 is a block diagram of the network connections of the array of instruments in FIG. 4. In this case one of the instruments, e.g. Altimeter 405, contains the Sensor System PCB. It's network PCB 505 communicates to the other network PCBs 500, 501, 502, 503 and 504 (contained in the other instruments) typically over the RS-485 communications interface, network connection 506 (although it should be understood that other communications standards can be used.) The other instruments, not containing the optional Sensor System need information from specific components of the Sensor System in order to operate.

FIG. 6 is a menu display of the present invention in a replacement application. In this case, one Electronic Flight Instrument is located in the instrument panel. The optional Sensor System is installed. When a standard instrument fails, the user switches on the Electronic Flight Instrument allow the user to select an instrument from the menu as a replacement instrument.

Other instruments besides the “Basic Six” that may be selected are G-meter, Clock/Timer, Terrain display, Traffic display, Weather display, ADS-B display, Course Deviation Indicator (CDI), Automatic Direction Finder (ADF), Horizontal Situation Indicator (HSI), etc.

We claim:

1. An electronic flight instrument configured to fit in a standard instrument mount and an array of standard instruments including: an electronic display; a processor for controlling the electronic display, a network interface or interfaces for communicating with other instruments or sensors; and an optional sensor system.

2. The electronic flight instrument of claim 1 wherein the standard instrument mount is for 2.25″ instruments.

3. The electronic flight instrument of claim 1 wherein the standard instrument mount is for 3.125″ instruments.

4. The electronic flight instrument of claim 1 wherein the electronic display is a Liquid Crystal Display.

5. The electronic flight instrument of claim 1 wherein the network interface includes at least one serial interface.

6. The electronic flight instrument of claim 1 wherein the network interface includes at least one Ethernet interface.

7. The electronic flight instrument of claim 1 wherein the Sensor System includes a Global Positioning System sensor.

8. The electronic flight instrument of claim 1 wherein the Sensor System includes a three axis accelerometer.

9. The electronic flight instrument of claim 1 wherein the Sensor System includes a rate gyro on each of the yaw, pitch and roll axes.

10. The electronic flight instrument of claim 1 wherein the Sensor System includes pressure sensors for airspeed and altitude sensing.

11. The electronic flight instrument of claim 1 wherein the Sensor System includes a Magnetometer for heading sensing.

12. An electronic flight instrument configured to fit in a standard instrument mount including: an electronic display; a processor for controlling the electronic display; a sensor system; and a selection method for selecting the operation of the instrument to allow emulation of any one of the “basic six” instruments or other instruments.

13. The electronic flight instrument of claim 12 wherein the standard instrument mount is for 2.25″ instruments.

14. The electronic flight instrument of claim 12 wherein the standard instrument mount is for 3.125″ instruments.

15. The electronic flight instrument of claim 12 wherein the electronic display is a Liquid Crystal Display.

16. The electronic flight instrument of claim 12 wherein the Sensor System includes a Global Positioning System sensor.

17. The electronic flight instrument of claim 12 wherein the Sensor System includes a three axis accelerometer.

18. The electronic flight instrument of claim 12 wherein the Sensor System includes a rate gyro on each of the yaw, pitch and roll axes.

19. The electronic flight instrument of claim 12 wherein the Sensor System includes pressure sensors for airspeed and altitude sensing.

20. The electronic flight instrument of claim 12 wherein the Sensor System includes a Magnetometer for heading sensing.

21. The electronic flight instrument of claim 12 wherein the selection method includes a menu display.

22. The electronic flight instrument of claim 12 wherein the selection method includes operation of user switches to step through the emulated instruments.
